(19) United States
(12) Patent Application Publication
(10) Pub. No.: US 2010/0095869 A1
(43) Pub. Date: Apr. 22, 2010

(54) METHOD FOR MANUFACTURING AN AQUEOUS SUSPENSION OR DISPERSION CONTAINING CALCIUM CARBONATE AND KAOLIN AND ITS USE IN THE MANUFACTURING OF PAPER COATINGS

(75) Inventors: Francois Dupont, Lyon (FR); Jacques Mongoin, Quincieux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Coatex S.A.S., Genay (FR)

(21) Appl. No.: 12/519,794

(22) PCT Filed: Dec. 4, 2007
(86) PCT No.: PCT/IB2007/003894

§ 371 Date: Jun. 18, 2009

(30) Foreign Application Priority Data
Dec. 20, 2006 (FR) 06/11112

(51) Int. Cl. C09C 1/02; C08K 3/26

(52) U.S. Cl. 106/464; 524/425

(57) ABSTRACT

The invention consists of a method for manufacturing an aqueous suspension or dispersion of calcium carbonate and kaolin, via steps of manufacturing, potentially in the presence of a dispersing agent or grinding agent, an aqueous suspension or dispersion of calcium carbonate with a solids content less than 70% of its weight, and of adding kaolin in dry powder form so as to achieve a ratio, by dry weight (precipitated calcium carbonate:kaolin) between (90:10) and (10:90).

The other objects of the invention reside in the aqueous suspensions or dispersions thereby obtained, and their use in manufacturing paper coatings, which make it possible to obtain improved optical properties in the end product.

### TECHNICAL FIELD

The general technical field related to the present invention is that of paper, and more precisely, coated sheets of paper. More specifically, this technical field is that of aqueous suspensions and dispersions of mineral materials, particularly including natural calcium carbonate (GCC) or synthetic calcium carbonate (PCC) and kaolin, and their manufacturing methods, these aqueous suspensions and dispersions then being used in the manufacturing of paper coatings which enable the coating of the sheet of paper, while improving its optical properties. In the remainder of the present Application, the expression “end product” shall denote the sheet of paper coated using a paper coating, said paper coating being a formulation containing mineral materials such as calcium carbonate and kaolin, said mineral materials having been added into said paper coating in the form of aqueous dispersions.

When manufacturing a sheet of paper through coating, an aqueous compound known as “paper coating”, which particularly contains water, one or more mineral materials, one or more binders, and various additives, is applied onto a paper medium. The most commonly used mineral materials in paper coatings are natural calcium carbonate (or GCC for “Ground Calcium Carbonate”) or synthetic calcium carbonate (or PCC for “Precipitated Calcium Carbonate”), and kaolin.

Kaolin gives the end product properties of gloss, opacity, and printability, as indicated in the document “Industrial clays case study” (Murray, H, Mining Minerals and Sustainable Development, May 2002, 64, pp 1-9), whereas calcium carbonate chiefly provides the sheet of paper with whiteness, while also contributing to the improvement of its gloss and printability, as noted in the document “Influences of pigments on runnability and quality of LWC offset printing paper” (Wochenblatt für Papierfabrikation, 126 (4), 1998, pp 137-141).

There are numerous documents about manufacturing a paper coating by using at least two mineral materials, one of which is a calcium carbonate and the other a kaolin. In particular, one may cite the document U.S. Pat. No. 5,120,365, which describes mixtures of calcium carbonate- and talc-based pigments, potentially with kaolin, such mixtures being used in the formulation of paper coatings, which makes it possible to achieve good optical properties in the coated paper. Also known is the document WO 03/93577, based on improving of the optical properties of a coated sheet of paper, and which describes pigment compounds based on kaolin and a natural or synthetic calcium carbonate, as these mineral materials exhibit particular particle distribution size properties. Also known is the document “Effect of kaolin addition to calcium carbonate precoats” (Wochenblatt für Papierfabrikation, 126 (4), 1998, pp 137-141), which describes the effects resulting from mixing various kaolins with two natural calcium carbonates that differ in form factor. Finally, one may mention the document “Influences of pigments on runnability and quality of LWC offset printing paper” (Wochenblatt für Papierfabrikation, 126 (4), 1998, pp 137-141), already cited herein, which describes the coating of paper using paper coatings containing mixtures of a natural calcium carbonate (Hydrocarb™ sold by the company OMYA™) and various kaolins.

While emphasizing that these documents focus on the manufacturing of paper coatings, the Applicant notes that the particular technical field relating to the present invention is that of the methods for manufacturing aqueous suspensions and dispersions of mineral materials which are then used in the manufacturing of paper coatings, and not the field of methods for manufacturing these paper coatings. Consequently, it is important to emphasize that the technical problem covered by the present Application is that of manufacturing aqueous suspensions of mineral materials based on calcium carbonate and kaolin, for the purposes of improving the optical properties of the final paper.

Consequently, although the aforementioned documents note some of the advantages granted by using calcium carbonate and kaolin in manufacturing a paper coating, they do not contain any particular information on the methods used to obtain such kaolins and calcium carbonates beforehand. The description of this knowledge, as it exists today in the state of the art, is the subject of the text below.

### STATE OF THE ART

A person skilled in the art knows that calcium carbonate and kaolin are currently added to paper coatings, in the form of two separate aqueous suspensions or dispersions, each containing one of these mineral materials. Calcium carbonate and kaolin are therefore added to the paper coating, each in the form of an aqueous suspension or dispersion containing the mineral material in question, and exhibiting, for economic or technical reasons, a high solids content: i.e. containing at least 60%, preferentially 70%, and very preferentially 72% by dry weight of calcium carbonate or kaolin (throughout the Application, the term “solids content” shall denote the content of mineral material by dry weight, compared to the total weight of the aqueous suspension or dispersion in question). Each of these dispersions or suspensions is then implemented, so as to obtain, within the paper coating, a proportion by dry weight (calcium carbonate:kaolin) between (90:10) and (10:90).

The ways to manufacture these aqueous suspensions and dispersions of both kaolin and calcium carbonate will now be described, explaining:
first, how to successfully manufacture such dispersions or suspensions with a solids content at least greater than 60% of their total weight,
and second, how to successfully manufacture such dispersions or suspensions with the purpose of granting the final paper improved optical properties.

### State of the Art: Kaolin

With respect to kaolin, it is necessary to know that it is mainly found in the Americas: In Brazil, as well as in the United States, particularly Georgia and South Carolina, as noted in the document “Industrial clays case study”, already mentioned hereinabove. Kaolin is conventionally obtained through processes of ore extraction, grinding, delamination, and then potentially treatment and classification. For cost-related reasons, American and Brazilian kaolin producers have long opted to transport their products over great distances in the form of a dry powder.

This dry powder is obtained via a step of drying, particularly through spray-drying. This kaolin must then be placed in an aqueous dispersion, before being added to the paper coating, with this step of placement in an aqueous dispersion frequently taking place in the presence of a kaolin dispersion agent. This step is necessary to provide the paper coating manufacturer with a liquid product, which is easier to handle and less volatile than a powder product, and which also has a high solids content enabling the manufacturer to formulate its paper coatings so that they in turn have a high solids content.

Additionally, this step must, as efficiently as possible, disagglomerate the kaolin agglomerates that formed during the step of drying. This is because it is well known that drying a mineral material, particularly through spray-drying, leads to the formation of particle agglomerates: This is indicated in the document “Spray dried products—characterization of particle morphology” (TransIChemE, vol. 77, part A, January 1999, pp. 21-38) with respect to drying kaolin. However, according to the basic knowledge of a person skilled in the art, the presence of agglomerates constitutes a negative factor in achieving good optical properties in the final product, particularly including its gloss: gloss is particularly influenced by the use of the finest particles possible.

Using the methods described above, products are therefore obtained in liquid forms, which are aqueous suspensions and dispersions of kaolin whose content by dry weight is greater than 60% of their total weight, and whose proportion of agglomerates was reduced owing to the step of dispersing the kaolin powder in water.

### State of the Art: Calcium Carbonate

With respect to calcium carbonate, it is important to note beforehand that certain calcium carbonates make it possible to grant the final paper improved optical properties. Generally speaking, they are calcium carbonates which have a “vertical” or “narrow” particle size distribution (or PSD). In concrete terms, the percentage by weight of particles whose diameter is less than a certain value is displayed, with it being possible to take this measurement using a Sedigraph™ device: the more vertical the resulting curve is, the more vertical the particle size distribution is said to be. This also means that the distribution of all particle sizes around a mean value corresponding to the mean diameter of said particles is straight: thus, “narrow” particle size distributions are also referred to. However, numerous documents emphasize that a narrow particle size distribution is a necessary condition for achieving good optical properties within the paper, particularly including its opacity. For this purpose, the documents “Taking advantages of pigment performance through binder flexibility” (Paper Technology, 46 (8), 2005, pp 12-16) and “Maintaining coated paper performance while varying coating color solids with engineered carbonates” (Coating and Graphic Arts Conference and Exhibit, Baltimore USA, pp. 312-324, 2004) may be cited.

More precisely, these aqueous dispersions of particular calcium carbonates exhibiting both a narrow PSD and a high solids content (greater than 60%) are:
either PCC-based, said PCCs being obtained through in-situ dispersion or precipitation (potentially in the presence of a dispersing agent) and having a solids content less than about 40%, then through at least one step of concentration,
or GCC-based, said GCCs being obtained through a step of grinding (potentially in the presence of a dispersing or grinding aid agent) and having a solids content less than about 40%, followed by at least one step of concentration.

The prior art regarding these methods will now be described.

State of the Art Regarding Calcium Carbonate: Aqueous Suspensions and Dispersions of PCC with a Narrow PSD and/or a Solids Content Greater than 60%

The person skilled in the art is familiar with document WO 98/25854, which describes a PCC used in coating paper, whose gloss it improves. The technical problem solved by this document is disclosing a PCC manufacturing method implementing a step of concentration while limiting the quantity of dispersing agent used. This method comprises steps of forming a PCC suspension with a low solids content (15% according to the four examples in the document), the treatment and then concentration thereof through filtration in the presence of a non-ionic surface active agent, so as to obtain a filtration cake exhibiting a solids content between 55% and 80% by dry weight of PCC in relation to its total weight.

He is also familiar with the document EP 0,768,344, which describes a PCC manufacturing method intended to be implemented in paper coatings, while bestowing good optical properties onto the coated paper: gloss, whiteness, and opacity. The technical problem solved by this document is disclosing a PCC manufacturing method without forming agglomerates of that mineral material; these agglomerates alter the paper's optical properties. This method comprises steps of lime carbonation in an aqueous medium so as to obtain an aqueous suspension of PCC with a slightly high solids content (18% according to the examples in this document), concentration and then grinding. Example 1 of this document clearly shows that if the person skilled in the art wishes to obtain a solids content greater than 70% in the final suspension, he must make use of two concentration steps.

He is also familiar with the document U.S. Pat. No. 4,242,318, which describes a PCC manufacturing method intended to be used in paper coatings. The technical problem solved by this document is disclosing an economical method for manufacturing an aqueous suspension of PCC, which is stable for at least 30 days and has a solids content greater than 65% of its weight. This method comprises steps of crystallizing PCC in an aqueous medium in the presence of a polyelectrolyte, mechanical concentration to obtain a filtration cake, then fluidization and homogenization of the cake by means of a dispersing agent. It is indicated that an aqueous suspension is thereby obtained, exhibiting a high solids content (71.2% according to example 2) without adding dry matter (column 3, line 41). It is also noted that a PCC is obtained with a very narrow particle size distribution or PSD, which makes it particularly suitable to be implemented in the manufacturing of paper (column 4, line 66-column 5, line 2).

Additionally, one piece of information in the state of the art regarding methods for manufacturing aqueous suspensions or dispersions of PCC, which may be used in coating paper, is that a first step of manufacturing an aqueous suspension or dispersion with a solids content roughly less than 40% must be implemented, followed by at least one step of concentration in order to obtain a dispersion or suspension with a solids content greater than 60% of its weight. This results in aqueous suspensions or dispersions of PCC exhibiting a narrow PSD which, when they are implemented in formulating paper coatings, lead to coated sheets of paper with good optical properties, particularly in terms of opacity.

State of the Art Regarding Calcium Carbonate: Aqueous Suspensions or Dispersions of GCC Exhibiting a Narrow PSD and/or a Solids Content Greater than 60%.

In this field, the person skilled in the art is familiar with the document WO 01/48093, which describes the use of homopolymers and copolymers of acrylic acid with another acrylic, allylic or vinylic acid as a dispersing agent for mineral materials, with a viscosity index between 0.08 and 0.8. These dispersing agents are implemented after a first step of grinding without a dispersing agent, which leads to a low solids content (though without this being stated) and a second step of mechanical or thermal concentration. First, although there is no value to quantify the “low solids content” obtained after the grinding step, the analogy which is made with document EP 0,850,658 (page 2, line 13) makes it possible to deduce that it is at most equal to 40%. Second, the term “reconcentration”, broadly used in this document WO 01/48093, clearly indicates that at least two concentration steps must be implemented in this invention. Example 7 demonstrates that an aqueous suspension of GCC is thus obtained, whose solids content is equal to 72% of its weight. The mineral materials thereby obtained are particularly used in the formulation of paper coatings, as demonstrated by example 9, thereby making it possible to improve the opacity of the coated paper with said paper coatings.

He is also familiar with the document EP 0,850,685. The technical problem solved by this document is suspending mineral particles (particularly GCC) derived from a step of low-concentration grinding without a dispersing agent, and a mechanical and/or thermal reconcentration step. The method which is the object of this invention comprises the steps of manufacturing an aqueous suspension of GCC with a solids content less than 40% of its total weight, concentrating the suspension so as to obtain a solids content at least equal to 60%, then adding a dispersing agent which is a copolymer of acrylic acid and maleic acid (in a molar ratio of 0.5/1 to 10/1, and with a molecular weight between 1000 g/mole and 100,000 g/mole). This document therefore implements at least one step of concentration, for the purpose of obtaining a final solids content greater than 60%. Additionally, the examples of this document, which describe only one step of concentration, do not make it possible to obtain a solids content greater than 70% of the total weight of the suspensions manufactured. It is therefore legitimate to think that a step of reconcentration is necessary to obtaining a solids content greater than 70% by weight. Finally, this document clearly indicates that aqueous suspensions of GCC manufactured in this manner exhibit a narrow PSD (col. 3, lines 19-28), and that they may advantageously be used in paper coating.

Additionally, one piece of information in the state of the art regarding methods for manufacturing aqueous suspensions or dispersions of GCC, that may be used in coating paper, is that a first step of manufacturing an aqueous suspension or dispersion, particular through grinding, with a solids content roughly less than 40% of its weight must be implemented, followed by at least one step of concentration in order to obtain a dispersion or suspension with a solids content greater than 60% of its weight. This results in aqueous suspensions or dispersions of GCC exhibiting a narrow PSD which, when they are implemented in formulating paper coatings, lead to coated sheets of paper with good optical properties, particularly in terms of opacity.

### OBJECT OF THE INVENTION

Continuing her research into manufacturing aqueous suspensions or dispersions of calcium carbonate and kaolin that improve the optical properties of the end product, particularly including its opacity, the Applicant has developed a new method characterized in that it comprises steps of:
a) manufacturing, potentially in the presence of at least one dispersing agent and/or at least one grinding aid agent, an aqueous suspension and/or dispersion of natural and/or precipitated calcium carbonate having a solids content between 45% and 70%, preferentially between 55% and 70%, and very preferentially between 60% and 70% of its total weight.
b) adding powdered kaolin to the dispersion and/or suspension obtained after step a), so as to obtain an aqueous suspension and/or dispersion exhibiting a ratio by dry weight (calcium carbonate:kaolin) between (90:10) and (10:90), preferentially between (90:10) and (50:50), and very preferentially between (80:20) and (60:40).

A first advantage of the inventive method is that it provides the person skilled in the art with both of the mineral materials that he wishes to add to the paper coating, in the form of a single product and in the desired ratios, unlike with the prior art, which separately implemented an aqueous dispersion of calcium carbonate and an aqueous dispersion of kaolin.

Secondly, as shown by the examples supporting the present Application, the inventive method leads to aqueous suspensions and/or dispersions whose solids content may be relatively high, particularly greater than 65%, preferentially 70%, and very preferentially 72% of their total weight: i.e. at least equal to or greater than the solids content of the dispersions of kaolin or calcium carbonate of the prior art, but with the same economical and technical advantages. As these examples additionally demonstrate, the viscosities of such dispersions and/or suspensions are perfectly suited to the easy transporting and handling of such products.

Another advantage of the inventive method is that it has turned out to be more economical than the methods of the prior art, because it bypasses the concentration steps implemented in the prior art while maintaining the paper's optical properties. It is important to note that these concentration steps are indeed relatively costly, considering not only the energy that they use, but also the need to have access to devices whose installation and maintenance are very expensive (such as centrifuges, or thermal or mechanical evaporators).

Additionally, it is completely surprising that the inventive method leads to aqueous dispersions and/or suspensions of mineral materials containing calcium carbonate and kaolin which, when used to manufacture paper coatings, make it possible to achieve good optical properties in the paper coated using said paper coatings. Indeed, as shown by the analysis in the prior art, it is (based on prior knowledge) preferable to initially manufacture an aqueous suspension or dispersion of GCC and PCC with a low solids content (less than 40%) for the purpose of obtaining a narrow PSD, which will make it possible to improve the paper's optical properties, such as its opacity: the present invention is inconsistent with this information, because it implements a first step of manufacturing with a solids content between 45% and 70%, preferentially between 55% and 70%, and very preferentially between 60% and 70%.

Without wishing to be bound to any theory whatsoever, the Applicant thinks that the concentration steps implemented in the prior art, and needed to provide concentrated products, actually have a negative impact on the end product's optical properties. Even though a first step of grinding or dispersion at a low concentration (which is a factor that leads to obtaining narrow PSD and therefore, based on prior knowledge, good optical properties for the paper), these later steps of concentration tend to minimize this benefit.

There is also another surprising element, with respect to the ability to obtain, using the inventive method, aqueous suspensions and/or dispersions containing calcium carbonate and kaolin, and making it possible to achieve good gloss in the end product: this is adding kaolin in the form of a dry powder. Indeed, these kaolin powders are obtained by a step of drying aqueous suspensions of kaolin, particularly through spray-drying: however, it has already been noted that this type of drying leads to the formation of particle agglomerates, and that the presence of such agglomerates is a factor that harms the optical properties of the paper, particularly including its gloss. It is therefore entirely surprising that the gloss of the end product is maintained and even improved via the inventive method, compared with the methods of the prior art.

Without wishing to be bound to any theory whatsoever, the Applicant thinks that within the invention, when the dry kaolin (which has agglomerates) is added to the aqueous dispersion of calcium carbonate, the particles of said carbonate behave as disagglomerating agents for the “large” kaolin particles. This results in a decrease in the quantity of kaolin agglomerates, which would explain why the end gloss of the coated paper is not degraded by the invention, and is indeed improved when compared to the prior art.

### DETAILED OBJECT OF THE INVENTION

Thus, a first object of the invention is a method for manufacturing an aqueous suspension and/or dispersion of calcium carbonate and kaolin, characterized in that it comprises the steps of:
a) manufacturing, potentially in the presence of at least one dispersing agent and/or at least one grinding aid agent, an aqueous suspension and/or dispersion of natural and/or precipitated calcium carbonate, with a solids content between 45% and 70%, preferentially between 55% and 70%, and very preferentially between 60% and 70% of its total weight,
b) adding powdered kaolin to the dispersion and/or suspension obtained after step a), so as to obtain an aqueous suspension and/or dispersion exhibiting a ratio by dry weight (calcium carbonate:kaolin) between (90:10) and (10:90), preferentially between (90:10) and (50:50), and very preferentially between (80:20) and (60:40).

In a first variant, in which the calcium carbonate is a natural calcium carbonate (GCC), this method is characterized in that it comprises the steps of:
a) manufacturing through grinding in water, in the presence of at least one dispersing agent and/or at least one grinding aid agent, an aqueous suspension and/or dispersion of natural calcium carbonate, with a solids content between 45% and 70%, preferentially between 55% and 70%, and very preferentially between 60% and 70% of its total weight,
b) adding powdered kaolin to the dispersion and/or suspension obtained after step a), so as to obtain an aqueous suspension and/or dispersion exhibiting a ratio by dry weight (natural calcium carbonate:kaolin) between (90:10) and (10:90), preferentially between (90:10) and (50:50), and very preferentially between (80:20) and (60:40).

According to this variant, the inventive method is characterized in that the natural calcium carbonate (GCC) is chosen from among a limestone, a chalk, a calcite, a marble, and mixtures thereof.

This variation appears to be further inventive in that the natural calcium carbonate does not lead to good optical properties, unlike PCC, as disclosed by document EP 1,340,795 ([0007]): a person skilled in the art therefore wishes to chiefly use PCC. If he wants to use a GCC, he will obviously be able to use the concentration methods described in the prior art (the aforementioned patents WO 01/48093 and EP 0,850,685). Implementing a GCC in accordance with the invention, without recourse to a concentration step, is therefore synonymous with an inventive step.

Additionally, the document EP 1,340,795 only clearly and unambiguously discloses two examples, which deal with manufacturing a suspension of PCC and kaolin. This does not anticipate the invention claimed here: a method regarding GCC, from which an aqueous suspension is manufactured with the solids contents given above; a suspension wherein dry kaolin is added in the proportions also given above.

Likewise, the document EP 0,521,737 only discloses the particular situation of PCC: this does not anticipate the GCC situation with respect to novelty, and strengthens the inventive step of the present invention, which relies upon GCC and not PCC, as given in this document EP 0,521,737.

In a second variant in which the calcium carbonate is a precipitated calcium carbonate (PCC), this method is characterized in that it comprises the steps of:
a) manufacturing, through dispersion in water and/or in-situ precipitation in water, potentially in the presence of at least one dispersing agent, an aqueous suspension and/or dispersion of precipitated calcium carbonate, having a solids content between 45% and 70%, preferentially between 55% and 70%, and very preferentially between 60% and 70% of its total weight.
b) adding powder-form kaolin to the dispersion and/or suspension obtained after step a), so as to obtain an aqueous suspension and/or dispersion exhibiting a ratio by dry weight (precipitated calcium carbonate:kaolin) between (90:10) and (10:90), preferentially between (90:10) and (50:50), and very preferentially between (80:20) and (60:40).

According to this variant, the inventive method is characterized in that the precipitated calcium carbonate is chosen from among a calcite, an aragonite, a vaterite, and mixtures thereof.

Generally, the inventive method is further characterized in that it uses, during step a), a quantity of dispersing agent and/or grinding aid agent by dry weight between 0.1% and 3%, preferentially between 0.3% and 1%, and very preferentially between 0.4% and 0.8%, compared with the dry weight of the calcium carbonate.

Generally, the inventive method is further characterized in that the dispersing agent and grinding aid agent are a homopolymer or copolymer of (meth)acrylic acid, which is fully or partially neutralized by at least one neutralization agent.

A person skilled in the art will know how to adapt the choices of neutralization agents, molecular weight, said agent's polymolecularity index, based on the characteristics of the aqueous suspension or dispersion that he seeks to obtain (such as the solids content, viscosity, particle size distribution of the calcium carbonate particles, etc.).

However, in a very preferred variant of the invention, the inventive method is characterized in that the dispersing agent and the grinding aid agent are advantageously a homopolymer or copolymer of (meth)acrylic acid, which are fully neutralized, whose carboxylic sites' molar neutralization rate by a monovalent agent is between 20% and 80%, preferentially between 40% and 60%, and whose carboxylic sites' molar neutralization rate by a divalent agent is between 20% and 80%, and preferentially between 40% and 60%.

According to this variant, the inventive method is characterized in that the monovalent agent is sodium hydroxide and the monovalent agent is magnesium oxide.

Another object of the invention is constituted by aqueous suspensions and/or dispersions, characterized in that they are obtained by the inventive method.

A final object of the invention is constituted by the use of these aqueous suspensions and/or dispersions, in the manufacturing of paper coatings.

### EXAMPLES

### Example 1

This example illustrates the inventive method for manufacturing an aqueous dispersion of natural calcium carbonate and kaolin.

It also illustrates the dispersion thereby obtained according to the invention.

It also illustrates the inventive use of this dispersion in formulating a paper coating.

Finally, it illustrates the implementation of this paper coating to coat a sheet of paper, and demonstrates that the optical properties of said paper (gloss, opacity, and whiteness) are at least maintained, compared with the same paper coated using a paper coating obtained in accordance with the prior art (i.e. by adding two dispersions to the paper coating: one containing the calcium carbonate and resulting from a grinding followed by a concentration, the other one containing kaolin and resulting from dispersing said kaolin in water).

### Manufacturing the Aqueous Dispersion of Natural Calcium Carbonate According to Step a) of the Inventive Method

For each of the tests #1 to #3, we begin by grinding a natural calcium carbonate in water, in the presence of a grinding aid agent, so as to obtain an aqueous suspension whose content by dry weight of said carbonate is equal to 65% of its total weight.

### Test No. 1

This test implements 0.7% by dry weight, compared with the dry weight of calcium carbonate, a homopolymer of acrylic acid obtained through conventional polymerization, whose molecular weight is equal to 5,600 g/mole, of which 50% of the carboxylic sites by molar weight were neutralized by magnesium and 50% by molar weight of the carboxylic sites were neutralized by sodium.

### Test No. 2

This test implements 0.7% by dry weight, compared to the dry weight of calcium carbonate, a homopolymer of acrylic acid whose molecular weight is equal to 13,000 g/mole, fully neutralized by sodium. This homopolymer was obtained through the controlled radical polymerization technique RAFT, according to the technique implemented and described in the document FR 2,821,620.

### Test No. 3

This test implements 0.7% by dry weight, compared to the dry weight of calcium carbonate, a homopolymer of acrylic acid obtained through conventional polymerization, whose molecular weight is equal to 10,000 g/mole, fully neutralized by sodium.

For each of the dispersions obtained, the percentage by weight of particles whose mean diameter is less than 1 μm and 2 μm is determined, using a Sedigraph™ 5100 device sold by the company MICROMERITICS™. The Brookfield™ viscosities are also determined, at 25° C., at 10 and 100 revolutions per minute and using the appropriate mobile, at the moments t=0 and t=8 days before agitation, and t=8 days and after 30 seconds of agitation, respectively denoted μₜ₀, μ_{t8 BFAG} and μ_{t8 AFAG}. All of these results are given in Table 1.

TABLE 1

| | | Particle size | | Brookfield ™ viscosities | | | | | |
|---|---|---|---|---|---|---|---|---|---|
| Test | SC | distribution | | μₜ₀ | μₜ₀ | μ_{t8 BFAG} | μ_{t8 BFAG} | μ_{t8 AFAG} | μ_{t8 AFAG} |
| no. | (%) | % < 1 μm | % < 1 μm | 10 rpm | 100 rpm | 10 rpm | 100 rpm | 10 rpm | 100 rpm |
| 1 | 65 | 92.9 | 74 | 250 | 130 | 3100 | 1000 | 280 | 160 |
| 2 | 65 | 98.1 | 78 | 110 | 85 | 2040 | 650 | 130 | 120 |
| 3 | 65 | 97.5 | 75.4 | 130 | 110 | 2180 | 740 | 100 | 90 |

The Brookfield™ viscosities obtained demonstrate that the aqueous dispersions of calcium carbonate obtained in step a) of the inventive method are stable and fluid.

### Manufacturing the Dispersion of Calcium Carbonate and Kaolin by Adding Powdered Kaolin According to Step b) of the Inventive Method.

For each of the tests #4 to #6, a powdered kaolin sold by the company HUBER™ under the name Hydragloss™ 90 is added to the aqueous dispersions of calcium carbonate obtained for tests #1 to #3.

This addition is made in such a way as to achieve a ratio by dry weight (calcium carbonate:kaolin) equal to (70:30), as well as a solids content for the dispersion equal to 72% of its weight.

In the same manner as previously, Brookfield™ viscosities are determined for these aqueous dispersions, at 25° C., at 10 and 100 revolutions per minute, at the moments t=0, t=8 days before agitation, and t=8 days and after 30 seconds of agitation, respectively denoted μₜ₀, μ_{t8 BFAG} and μ_{t8 AFAG}.

TABLE 2

| | | Brookfield ™ viscosities | | | | | |
|---|---|---|---|---|---|---|---|
| Test | SC | μₜ₀ | μₜ₀ | μ_{t8 BFAG} | μ_{t8 AFAG} | μ_{t8 BFAG} | μ_{t8 AFAG} |
| no. | (%) | 10 rpm | 100 rpm | 10 rpm | 100 rpm | 10 rpm | 100 rpm |
| 4 | 72 | 1560 | 600 | 440 | 240 | 180 | 120 |
| 5 | 72 | 860 | 340 | 490 | 325 | 110 | 100 |
| 6 | 72 | 600 | 210 | 200 | 110 | 180 | 160 |

The Brookfield™ viscosities achieved demonstrate that the aqueous dispersions of calcium carbonate and kaolin obtained after step b) of the inventive method are stable and fluid.

Manufacturing Paper Coatings in Accordance with the Invention and the Prior Art.

### Test No. 7

For this test, which illustrates the prior art, a paper coating is created, in which the mineral materials (natural calcium carbonate and kaolin) are added in the form of two aqueous dispersions in accordance with the prior art:
in the form of an aqueous dispersion of calcium carbonate whose solids content is equal to 72% of its total weight, obtained by a step of low-concentration grinding without a dispersing agent followed by a thermal concentration step;
in the form of an aqueous dispersion of kaolin with a solids content equal to 72% of its total weight, obtained by dispersing a kaolin sold by the company HUBER™ under the name Hydragloss™ 90 in water, in the presence of 0.04% by dry weight, compared to the dry weight of the kaolin, of a sodium polyacrylate.

For tests #8 to #10, which illustrate the invention, a paper coating is created into which the mineral materials are added in the form of a single aqueous dispersion: These are the inventive aqueous dispersions, containing natural calcium carbonate and kaolin which were obtained for tests #4 to #6. The composition of the various paper coatings is indicated in table 3.

TABLE 3

| | SC | Test no. | | | |
|---|---|---|---|---|---|
| | (%) | 7 | 8 | 9 | 10 |
| Aqueous dispersion of CaCO₃ | 72 | 70 | | | |
| according to test #7 | | | | | |
| Aqueous dispersion of kaolin | 72 | 30 | | | |
| according to test #7 | | | | | |
| Aqueous dispersion of CaCO₃ | 72 | | 100 | | |
| and kaolin according to test #4 | | | | | |
| Aqueous dispersion of CaCO₃ | 72 | | | 100 | |
| and kaolin according to test #5 | | | | | |
| Aqueous dispersion of CaCO₃ | 72 | | | | 100 |
| and kaolin according to test #6 | | | | | |
| Latex DL 966 | 50 | 11 | 11 | 11 | 11 |
| Mowiol ™ 4/98 | 25 | 0.5 | 0.5 | 0.5 | 0.5 |
| Finnfix ™ | 10 | 0.6 | 0.6 | 0.6 | 0.6 |
| Blancophor ™ | — | 0.5 | 0.5 | 0.5 | 0.5 |

The figures in the columns corresponding to tests #7 to #10 indicate the share by weight of the various components in each case.

Additionally:
DL 966 refers to a styrene-butadiene latex sold by the company DOW™ CHEMICALS,
Mowiol™ 4/98 refers to a polyvinylic alcohol sold by the company CLARIANT™,
Finnfix™ refers to a carboxymethylcellulose sold by the company BASF™,
Blancophor™ refers to an optical brightener sold by the company BAYER™.

Table 4 indicates the values of the Brookfield™ viscosities, at 25° C. and at moment t=0, measured at 10 and 100 revolutions per minute for all of these paper coatings.

TABLE 4

Test no.

| | 7 | 8 | 9 | 10 |
|---|---|---|---|---|
| Brookfleld viscosity ™ (t0) | 7560 | 7840 | 8620 | 8700 |
| 10 rpm | | | | |
| Brookfleld viscosity ™ (t0) | 1310 | 1350 | 1500 | 1470 |
| 100 rpm | | | | |

The Brookfield™ viscosities, measured at moment t=0, at 10 and 100 revolutions per minute, are very close for the prior art and the invention.

### Coating Sheets of Paper According to the Invention and the Prior Art.

Each of the paper coatings corresponding to tests #7 (prior art) and #8 to #10 (invention) was used to coat a sheet of wood-free paper whose grammage was 58 g/m², respectively resulting in tests #11 (prior art) and #12 to #14 (invention). The coating was performed using a trailing-blade pilot coater, used to apply an amount of paper coating equal to 12±1 g/m² onto the paper medium. The coated paper that was obtained was then calendered by three successive applications of 40-bar pressure at 80° C.

The following were each determined for the coated and calendered sheets of paper corresponding to tests #11 (prior art) and #12 to #14 (invention):
W(CIE) whiteness in accordance with the ISO/FDIS 11475 standard,
opacity in accordance with the NFQ-03040 standard,
TAPPI 75° gloss in accordance with the TAPPI T480 OS-78 standard.

All of these results are given in Table 5.

TABLE 5

Test no.

| | 11 | 12 | 13 | 14 |
|---|---|---|---|---|
| Whiteness | 114 | 115 | 115 | 114 |
| Opacity | 87 | 87 | 88 | 87 |
| Gloss | 57 | 59 | 59 | 57 |

These results demonstrate that the optical properties of paper coated using paper coatings formulated in accordance with the present invention are surprisingly at least equal to the same properties obtained for the coated paper using the paper coating formulated in accordance with the prior art.

### Example 2

This example illustrates the inventive method for manufacturing an aqueous dispersion of natural calcium carbonate and kaolin. It also illustrates the inventive dispersion thereby obtained. It also illustrates the inventive use of this dispersion in formulating a paper coating. Finally, it illustrates the benefit of using the preferred inventive dispersing agent, which has particular neutralization rates for the monovalent neutralizing agent and the divalent neutralizing agent.

### Manufacturing the Aqueous Dispersion of Natural Calcium Carbonate According to Step a) of the Inventive Method

For each of the tests #15 to #18, we begin by grinding a natural calcium carbonate in water, in the presence of a grinding aid agent, so as to obtain an aqueous suspension whose content by dry weight of said carbonate is equal to 65% of its total weight.

### Test No. 15

This test implements 0.6% by dry weight, compared with the dry weight of calcium carbonate, a homopolymer of acrylic acid obtained through conventional polymerization, whose molecular weight is equal to 5,600 g/mole, of which 50% of the carboxylic sites by molar weight were neutralized by magnesium and 50% by molar weight of the carboxylic sites were neutralized by sodium. This test illustrates the preferential variant of the invention.

### Test No. 16

This test implements 0.6% by dry weight, compared with the dry weight of calcium carbonate, a homopolymer of acrylic acid obtained through conventional polymerization, whose molecular weight is equal to 5,600 g/mole, of which 90% of the carboxylic sites by molar weight were neutralized by magnesium and 10% by molar weight of the carboxylic sites were neutralized by sodium.

### Test No. 17

This test implements 0.6% by dry weight, compared with the dry weight of calcium carbonate, a homopolymer of acrylic acid obtained through conventional polymerization, whose molecular weight is equal to 5,600 g/mole, of which 10% of the carboxylic sites by molar weight were neutralized by magnesium and 90% by molar weight of the carboxylic sites were neutralized by sodium.

### Test No. 18

This test implements 0.6% by dry weight, compared with the dry weight of calcium carbonate, a homopolymer of acrylic acid obtained through conventional polymerization, whose molecular weight is equal to 5,600 g/mole, of which 100% of the carboxylic sites by molar weight were neutralized by sodium.

### Manufacturing the Dispersion of Calcium Carbonate and Kaolin by Adding Powdered Kaolin According to Step b) of the Inventive Method.

For each of the tests #19 to #22, two powdered kaolins sold by the company HUBER™ under the names Hydragloss™ 90 and Hydraprint™ are added to the aqueous dispersions of calcium carbonate obtained for tests #15 to #18.

This addition is carried out in such a way as to achieve:
a ratio by dry weight (calcium carbonate:kaolin) equal to (60:40),
a solids content of the dispersion equal to 72% of its weight,
the same quantity of both kaolins in the final suspension.
   Manufacturing Paper Coatings in Accordance with the Invention and the Prior Art.

### Test No. 23

For this test, which illustrates the prior art, a paper coating is created, in which the mineral materials (natural calcium carbonate and both kaolins) are added in the form of two aqueous dispersions in accordance with the prior art:
in the form of an aqueous dispersion of calcium carbonate whose solids content is equal to 72% of its total weight, obtained by a step of low-concentration grinding without a dispersing agent followed by a thermal concentration step;
in the form of an aqueous dispersion of kaolin with a solids content equal to 72% of its total weight, obtained by dispersing a mixture of kaolins sold by the company HUBER™ under the names Hydragloss™ 90 and Hydraprint™ in water, in the presence of 0.04% by dry weight, compared to the dry weight of the kaolin, of a sodium polyacrylate.

For tests #24 to #27, which illustrate the invention, a paper coating is created into which the mineral materials are added in the form of a single aqueous dispersion: These are the inventive aqueous dispersions, containing natural calcium carbonate and kaolin which were obtained for tests #19 to #22. The composition of the various paper coatings is indicated in table 6.

TABLE 6

| | SC | Test no. | | | | |
|---|---|---|---|---|---|---|
| | (%) | 23 | 24 | 25 | 26 | 27 |
| Aqueous dispersion of CaCO₃ | 72 | 60 | | | | |
| according to test #23 | | | | | | |
| Aqueous dispersion of kaolin | 72 | 40 | | | | |
| according to test #23 | | | | | | |
| Aqueous dispersion of CaCO₃ | 72 | | 100 | | | |
| and kaolin according to test | | | | | | |
| #24 | | | | | | |
| Aqueous dispersion of CaCO₃ | 72 | | | 100 | | |
| and kaolin according to test | | | | | | |
| #25 | | | | | | |
| Aqueous dispersion of CaCO₃ | 72 | | | | 100 | |
| and kaolin according to test | | | | | | |
| #26 | | | | | | |
| Aqueous dispersion of CaCO₃ | 72 | | | | | 100 |
| and kaolin according to test | | | | | | |
| #27 | | | | | | |
| Latex DL 966 | 50 | 11 | 11 | 11 | 11 | 11 |
| Mowiol ™ 4/98 | 25 | 0.4 | 0.4 | 0.4 | 0.4 | 0.4 |
| Finnfix ™ | 10 | 0.5 | 0.5 | 0.5 | 0.5 | 0.5 |
| Blancophor ™ | 0.6 | 0.6 | 0.6 | 0.6 | 0.6 | 0.6 |

The figures in the columns corresponding to tests #23 to #27 indicate the share by weight of the various components in each case.

### Coating Sheets of Paper According to the Invention and the Prior Art.

Each of the paper coatings corresponding to tests #23 (prior art) and #24 to #27 (invention) was used to coat a sheet of wood-free paper whose grammage was 36 g/m², respectively resulting in tests #28 (prior art) and #29 to #32 (invention). The coating was performed using a trailing-blade pilot coater, used to apply an amount of paper coating equal to 12±1 g/m² onto the paper medium. The coated paper that was obtained was then calendered by two successive applications of 40-bar pressure at 80° C.

The following was determined for the coated sheets of paper obtained:
W(CIE) whiteness in accordance with the ISO/FDIS 11475 standard,
opacity in accordance with the NFQ-03040 standard,
TAPPI 75° gloss in accordance with the TAPPI T480 OS-78 standard.

All of these results are given in Table 7.

TABLE 7

| | Test no. | | | | |
|---|---|---|---|---|---|
| | 28 | 29 | 30 | 31 | 32 |
| Whiteness | 80.0 | 81.5 | 81.0 | 80.9 | 80.8 |
| Opacity | 89.0 | 89.9 | 89.6 | 89.5 | 89.5 |
| Gloss | 55.0 | 58.0 | 57.2 | 57.3 | 57.1 |

These results demonstrate that the optical properties of paper coated using paper coatings formulated in accordance with the present invention are surprisingly superior to the same properties obtained for the coated paper using the paper coating formulated in accordance with the prior art.

These results, finally, demonstrate the benefit of implementing the preferential variant of the invention which corresponds to test #29.

1. A method for manufacturing an aqueous suspension of natural calcium carbonate, an aqueous dispersion of natural calcium carbonate, or a combination thereof, the natural calcium carbonate selected from the group consisting of a limestone, a chalk, a calcite, a marble, and a mixture thereof, comprising:
a) manufacturing an aqueous suspension of natural calcium carbonate, an aqueous dispersion of natural calcium carbonate, or a combination thereof having a solids content between 45% and 70% relative to the total weight of the aqueous suspension, aqueous dispersion, or combination thereof, and thereafter
b) adding powdered kaolin to the aqueous suspension, aqueous dispersion, or combination thereof, thereby exhibiting a calcium carbonate:kaolin ratio by dry weight of between (90:10) and (10:90).

2. The method according to claim 1, wherein said manufacturing occurs in the presence of at least one dispersing agent, at least one grinding aid agent, or a combination thereof, present in an amount by dry weight of between 0.1% and 3% compared with the dry weight of the calcium carbonate.

3. The method according to claim 2, wherein the at least one dispersing agent, at least one grinding aid agent, or combination thereof is a homopolymer or copolymer of (meth)acrylic acid, which is fully or partially neutralized by at least one neutralization agent.

4. The method according to claim 3, wherein the at least one dispersing agent, at least one the grinding aid agent, or combination thereof is a fully neutralized homopolymer or copolymer of (meth)acrylic acid, the carboxylic sites thereof exhibiting a molar neutralization rate by a monovalent agent of between 20% and 80%, and the carboxylic sites thereof exhibiting a molar neutralization rate by a divalent agent is of between 20% and 80%.

5. The method according to claim 4, wherein the monovalent agent is sodium hydroxide and the monovalent agent is magnesium oxide.

6. An aqueous suspension, an aqueous dispersion, or a combination thereof, obtained by the method according to claim 1.

7. (canceled)

8. The method according to claim 1, wherein the solids content is between 55% and 70% of the total weight of the aqueous suspension, an aqueous dispersion, or combination thereof.

9. The method according to claim 1, wherein the solids content is between 60% and 70% of the total weight of the aqueous suspension, an aqueous dispersion, or combination thereof.

10. The method according to claim 1, wherein the ratio is between (90:10) and (50:50).

11. The method according to claim 1, wherein the ratio is between (80:20) and (60:40).

12. The method according to claim 1, wherein said manufacturing occurs in the presence of at least one dispersing agent, at least one grinding aid agent, or a combination thereof, present in an amount by dry weight between 0.3% and 1% compared with the dry weight of the calcium carbonate.

13. The method according to claim 1, wherein said manufacturing occurs in the presence of at least one dispersing agent, at least one grinding aid agent, or a combination thereof, present in an amount by dry weight between 0.4% and 0.8% compared with the dry weight of the calcium carbonate.

14. The method according to claim 3, wherein the at least one dispersing agent, at least one the grinding aid agent, or combination thereof is a fully neutralized homopolymer or copolymer of (meth)acrylic acid, the carboxylic sites thereof exhibiting a molar neutralization rate by a monovalent agent of between 40% and 60%, and the carboxylic sites thereof exhibiting a molar neutralization rate by a divalent agent of between 20% and 80%.

15. The method according to claim 3, wherein the at least one dispersing agent, at least one the grinding aid agent, or combination thereof is a fully neutralized homopolymer or copolymer of (meth)acrylic acid, the carboxylic sites thereof exhibiting a molar neutralization rate by a monovalent agent of between 20% and 80%, and the carboxylic sites thereof exhibiting a molar neutralization rate by a divalent agent of between 40% and 60%.

16. The method according to claim 3, wherein the at least one dispersing agent, at least one the grinding aid agent, or combination thereof is a fully neutralized homopolymer or copolymer of (meth)acrylic acid, the carboxylic sites thereof exhibiting a molar neutralization rate by a monovalent agent of between 40% and 60%, and the carboxylic sites thereof exhibiting a molar neutralization rate by a divalent agent of between 40% and 60%.

17. A method for manufacturing an aqueous suspension of natural calcium carbonate, an aqueous dispersion of natural calcium carbonate, or a combination thereof, the natural calcium carbonate selected from the group consisting of a limestone, a chalk, a calcite, a marble, and a mixture thereof, comprising:
adding powdered kaolin to an aqueous suspension of calcium carbonate, an aqueous dispersion of calcium carbonate, or a combination thereof with a solids content between 45% and 70% relative to the total weight of the aqueous suspension, aqueous dispersion, or combination thereof to achieve a calcium carbonate:kaolin ratio by dry weight of between (90:10) and (10:90).

18. The method according to claim 17, wherein the ratio is between (90:10) and (50:50).

19. The method according to claim 17, wherein the ratio is between (80:20) and (60:40).
